(19) United States
(12) Patent Application Publication
(10) Pub. No.: US 2001/0046804 A1
(43) Pub. Date: Nov. 29, 2001

(54) Connector for flat ribbon cable

(75) Inventors: Helmut Fuchs, Halver (DE); Wilhelm Kippelt, Wuppertal (DE)

Correspondence Address: THE FIRM OF KARL F ROSS, 5676 RIVERDALE AVENUE, PO BOX 900, RIVERDALE (BRONX), NY, 10471-0900, US

(73) Assignee: Karl Lumberg GmbH & Co.

(21) Appl. No.: 09/815,378

(22) Filed: Mar. 22, 2001

(30) Foreign Application Priority Data
Mar. 22, 2000 (DE) 10014130.7

(51) Int. Cl. H01R 12/24

(52) U.S. Cl. 439/495

(57) ABSTRACT

A connector has a plastic base part forming a transversely elongated slot open in a longitudinal insertion direction and formed with a plurality of seats spaced along and opening into the slot. Respective contact elements fixed in the seats each have a deflectable contact arm with a contact point exposed in the slot at the respective seat to one side of the slot and a rigid pivot arm to an opposite side of the slot having an outer end spaced longitudinally outward from the respective contact point. A pivotal clamp part having a pusher bar extending along the slot inward of the arm outer ends is pivoted on the arm outer ends between an open position extending upward away from the base part and with the pusher bar spaced widely from the contact points and a closed position closely juxtaposed down on the base part and pressing a cable down on the points for contact of cable conductors therewith.

### FIELD OF THE INVENTION

The present invention relates to cable connector. More particularly this invention concerns a connector for electrically and mechanically connecting a flat ribbon cable to a printed-circuit board.

### BACKGROUND OF THE INVENTION

Standard ribbon cable with up to 50 conductors is the typical connection between the circuitry carried on a circuit board and the various other circuits, input devices, and the like of an electronic apparatus. The connection to the cable is semipermanent, that is the cable is connected up and normally only disconnected if the circuit board is to be replaced. It is important, therefore, that the connection be easy to make, be very durable, and be, if necessary, openable. The connector, in particular if used in a very small apparatus like a cell phone, must be as small and compact as possible.

As described in U.S. Pat. Nos. 4,477,137 of Ayer, 4,647,131 of VanWoensel, 4,586,827 of Hirsch, 4,900,269 of Lynch, 6,042,408 to Noro, and 6,056,571 also of Noro, as well as European patent applications EP 0,895,320 of Takayasu and 0,978,904 of Kunishi, these connectors are frequently quite complex. They are often made of several parts that must be meticulously machined and then assembled together, and even so some of them are bulky, loosen with time, or have other failings.

### OBJECTS OF THE INVENTION

It is therefore an object of the present invention to provide an improved ribbon-cable connector.

Another object is the provision of such an improved ribbon-cable connector which overcomes the above-given disadvantages, that is which is of simple construction, is very compact and easy to use, and which maintains a good connection for a long service life while still being, if necessary, releasable.

### SUMMARY OF THE INVENTION

A connector for a multiconductor ribbon cable has according to the invention a plastic base part forming a transversely elongated slot open in a longitudinal insertion direction and formed with a plurality of seats spaced along and opening into the slot. Respective contact elements fixed in the seats each have a deflectable contact arm with a contact point exposed in the slot at the respective seat to one side of the slot and a rigid pivot arm to an opposite side of the slot having an outer end spaced longitudinally outward from the respective contact point. A pivotal clamp part having a pusher bar extending along the slot inward of the arm outer ends is pivoted on the arm outer ends between an open position extending upward away from the base part and with the pusher bar spaced widely from the contact points and a closed position closely juxtaposed down on the base part and with, when an end of the ribbon cable is inserted in the slot, the pusher bar pressing the cable down on the points for contact of the cable conductors therewith.

This arrangement is extremely compact and sturdy. Pivotally mounting the pivotal part on the contact ensures perfect spacing of the pusher bar relative to the contact arms. The clamping force is effective between the arms of the contact element whose outer ends have circularly arcuate bearing portions centered on a pivot axis. The pivotal element rides on the bearing portion for pivoting about the axis. Moreover the contact elements are of metal and flat, lying in respective planes extending in the direction and substantially perpendicular to the axis. Thus they are capable of resisting considerable force, so that the base part and pivot part may be of light construction without losing any clamping effectiveness. The pivot arm in accordance with the invention is substantially wider and stiffer than the contact arm. This ensures that the contact arm will flex before the pivot arm.

The clamp part has a rear end spaced in the direction inward from the pusher bar. The rear end and base part are formed with interengageable hook formations releasably retaining the clamp part in the closed position. Thus the pivotal part is swung down from the open position and clipped in the closed position to hold there, unless the rear end is bent out to disengage the hook formations and open the connector.

The base part in accordance with the invention has an upper wall and the clamp part is formed with a central window in which the upper wall fits flush in the closed position. Thus when closed the entire connector has a very low profile.

The parts according to the invention are formed with interengaging formations preventing movement of the clamp part upward past the open position. These formations include a pair of sides on the clamp part having upwardly directed surfaces and downwardly directed surfaces on the base part confronting the upwardly directed side surfaces and engageable therewith in the open position. The sides are deflectable apart for fitting of the pivotal clamp part over the base part.

Each of the contacts has a foot projecting rearward from the base part and adapted to be soldered to a trace of a circuit board on which the base part is sitting. Furthermore a pair of mounting brackets have base flanges adapted to be fixed to the circuit board on which the base part is sitting and side flanges forming pivot upwardly directed pivot surfaces on which the clamp part rides on movement between its positions. The side flanges are formed with projections extending in the direction and the base part is formed with seats open in the direction and snugly receiving the projections. The brackets are metal.

### BRIEF DESCRIPTION OF THE DRAWING

The above and other objects, features, and advantages will become more readily apparent from the following description, reference being made to the accompanying drawing in which:

FIGS. 1 and 2 are sections through the connector according to the invention in the open and closed position;

FIGS. 3 and 4 are views taken in the directions of respective arrows III and IV of FIGS. 1 and 2;

FIGS. 5 and 6 are views taken in the directions of respective arrows V and VI of FIGS. 1 and 2;

FIG. 7 is a view like FIG. 3 but only showing the pivotal clamp part of the connector;

FIG. 8 is a view like FIG. 3 but only showing the fixed base part of the connector;

FIG. 9 is a view like FIG. 6 but only showing the movable clamp part of the connector;

FIG. 10 is a view like FIG. 6 but only showing the fixed base part of the connector;

FIGS. 11A and 11B are partial front views taken in the direction of respective arrows XIA and XIB of FIGS. 1 and 2;

FIGS. 12A and 12B are sections taken along respective lines XIIA—XIIA and XIIB—XIIB of FIGS. 1 and 2;

FIGS. 13 and 14 are sections taken along respective lines XIII—XIII and XIV—XIV of FIGS. 12A and 12B: and

FIG. 15 is a view like FIG. 2 but with geometric relationships illustrated.

### SPECIFIC DESCRIPTION

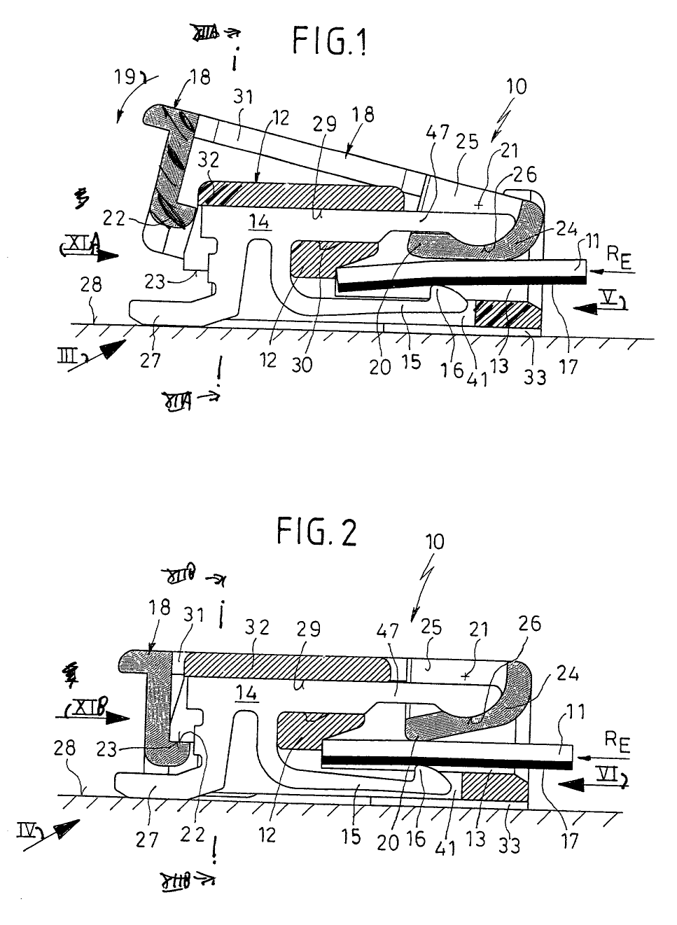

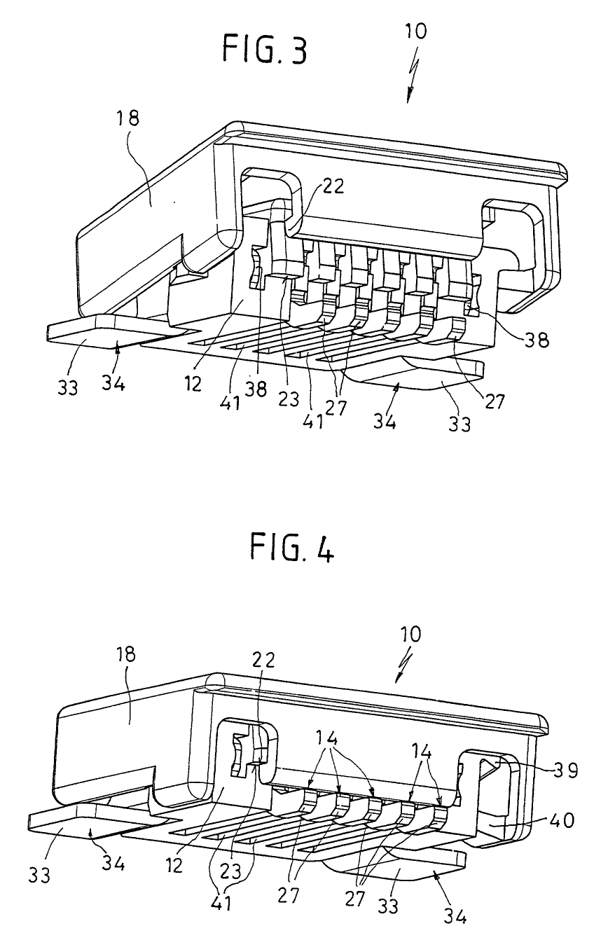

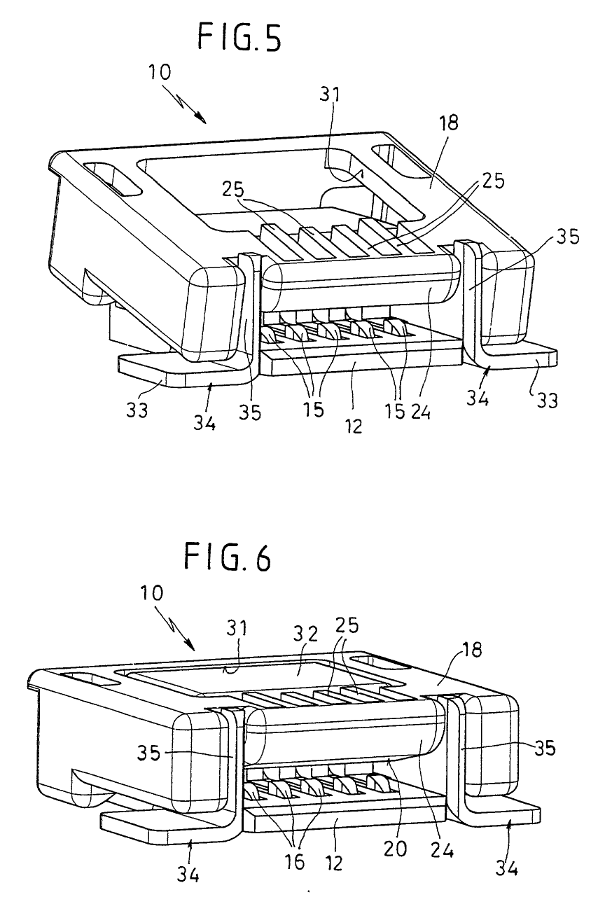

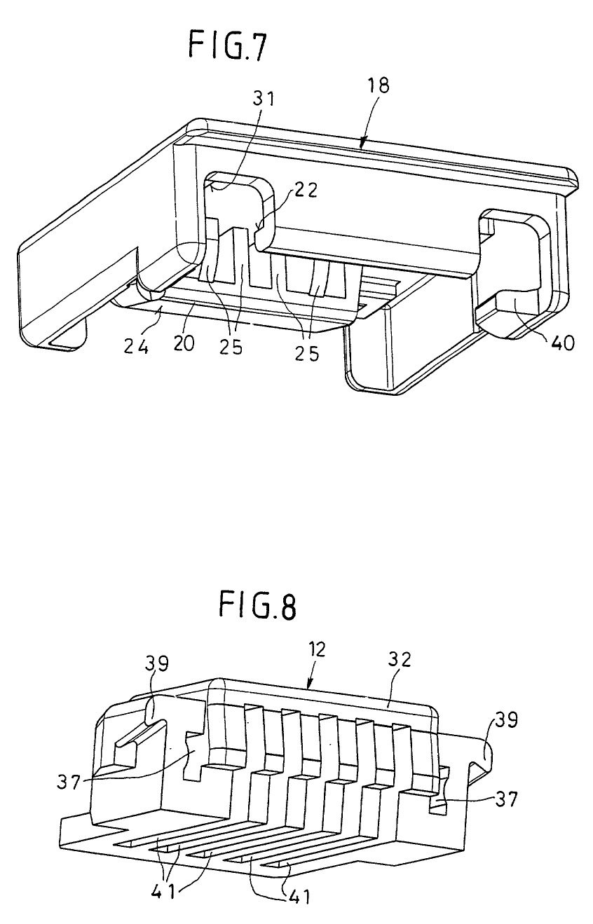

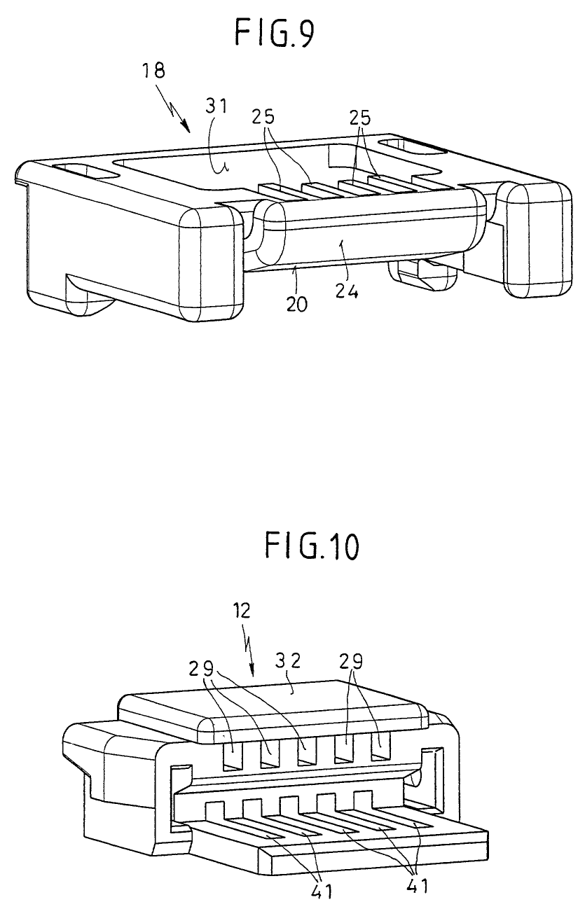

As seen in FIGS. 1 through 12B, a connector 10 according to the invention for a flat ribbon cable 11 has a molded plastic base part 12 and a pivotal clamp part 18 formed also of molded plastic. An end of the ribbon cable 11 fits in a slot mouth 13 formed between the parts 12 and 18. The cable 11 has conductors 17 spaced apart on center by 0.5 mm. The base part 12 holds a row of metallic contact elements 14 respectively engageable with the conductors 17. The connector 10 for a ten-conductor cable 11 measures overall 15.82 mm wide (perpendicular to the view plane of FIGS. 1 and 2), 2 mm high (vertical in FIGS. 1 and 2), and 5 mm deep (horizontal in the FIGS. 1 and 2). A connector for a twenty-conductor cable has the same height and depth, but is 20.8 mm wide.

Each contact element 14 lies substantially in a plane extending perpendicular to an insertion direction R_{E} of the cable 11 into the mouth 13 and to a planar printed-circuit board 28 on which the connector 10 is mounted. The contact elements 14 each have an upper arm 47 snugly fitted in a slot 29 formed in the stationary part 12, extending between webs 25 of the part 18, and having a tooth 30 digging thereinto and securing the contact element 14 in place. The outer end of each rigid upper arm 47 has a part-cylindrical lower surface 26 centered on an axis 21 and forming a bearing surface for an inner surface of an outer end portion 24 of the clamp part 18 so that same can rock on the aligned surfaces 26 about the axis 21 relative to the part 12. The contact elements 14 further each have an elastically deflectable lower arm 15 fitted in an upwardly open slot seat 41 of the body 12 and having a tooth 16 engageable with the respective a conductor 17 of the cable 11. Finally each contact element 14 has a rearwardly projecting foot or tab 21 by means of which it is soldered to a respective trace on the board 28, thereby forming an electrical connection between the respective conductor 17 of the cable 11 and the circuitry on the board 28.

The pivotal clamp part 18 is formed with a central window 31 into which fits an upper wall 32 of the base part 12 when in the closed FIG. 2 position. Thus when closed the part 18 adds nothing to the overall height of the connector 10. When in the closed position, a pusher bar 20 of the part 18 presses down atop the cable 11 to force its conductors 17 into solid contact with the respective teeth 16 of the connector arms 15. A front end of the clamp part 18 is formed with a hook 22 engageable under a stop 23 of the part 12 to releasably lock the connector 10 in the FIG. 2 closed position.

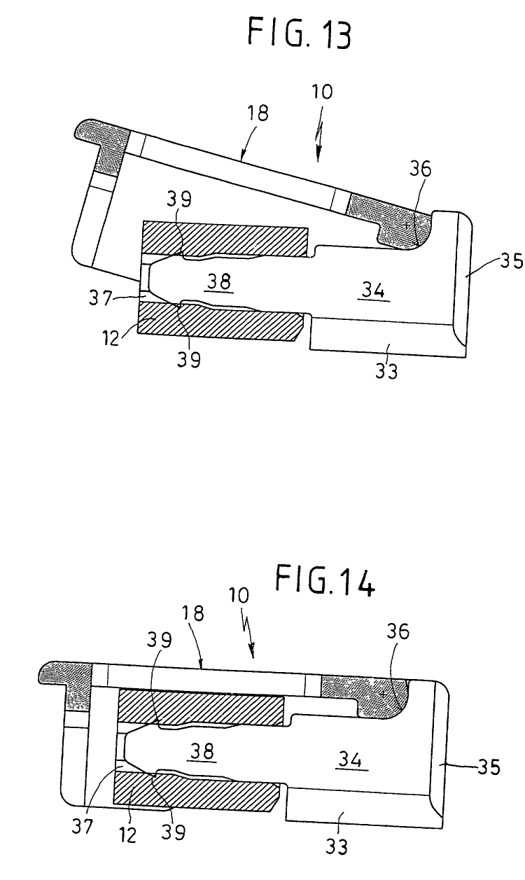

The connector 10 is further surface-mounted on the board 28 by metallic L-brackets 33 each having a horizontal base arm 33 adapted to be soldered or riveted to the board 28 and an upstanding arm 35 forming as shown in FIGS. 13 and 14 a part-cylindrical surface 36 centered on the axis 21 and on which an outer surface of the outer end portion 24 also rides as it pivots between the open and closed position. The two surfaces 26 and 36 thus effectively capture the portion 24 and prevent separation of the part 18 from the part 12. In addition each of the upright legs 35 is formed with a rearwardly projecting extension 38 engaging in a complementary slot seat 37 of the part 12 and having teeth 39 that dig into the walls of the seat 37 to solidly secure the part 12 to the brackets 34. Thus the brackets 34 are mounted on the board 28 and then the connector 10 is pushed over the extensions 38 to lock it to the brackets 34, whereupon the feet 27 are soldered in place to complete the electrical connection.

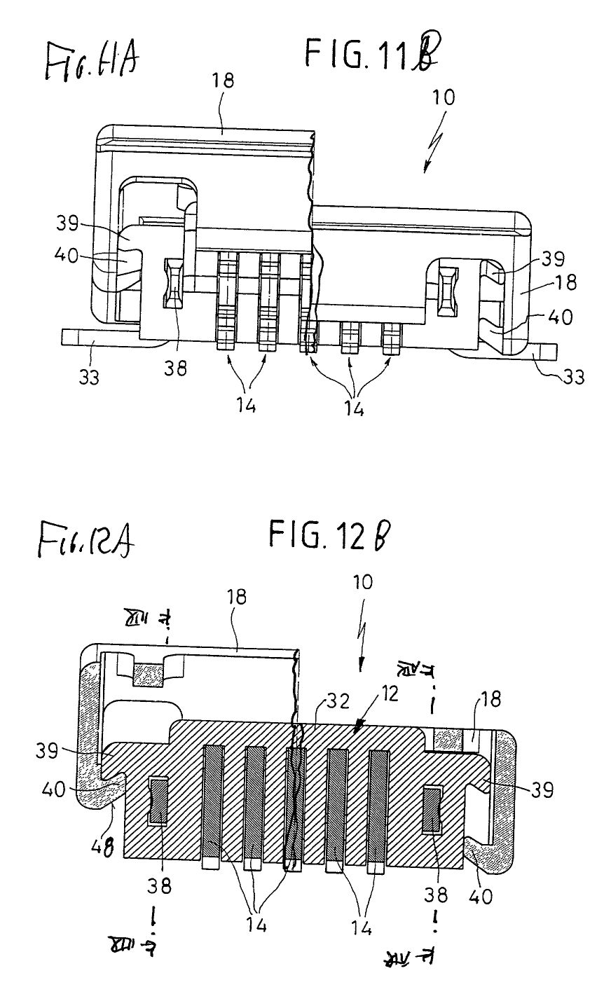

Sides of the base part 12 are formed as shown in FIGS. 11A, 11B, 12A, and 12B with downwardly directed hooks 39 engageable with upwardly directed hooks 40 on the sides of the clamp part 18 so as to arrest upward pivoting of the part 18 in the open position of FIGS. 1, 3, 5, 11A, and 12A. Bottom faces of the hooks 40 are beveled at 48 so that during assembly of the connector 10, the part 18 can be pushed down on the part 12, with the hooks 40 initially being deflected outward until they pass and snap into place under the hooks 39. Once the hooks 40 are past the hooks 39, they serve merely to limit upward pivoting of the part 18.

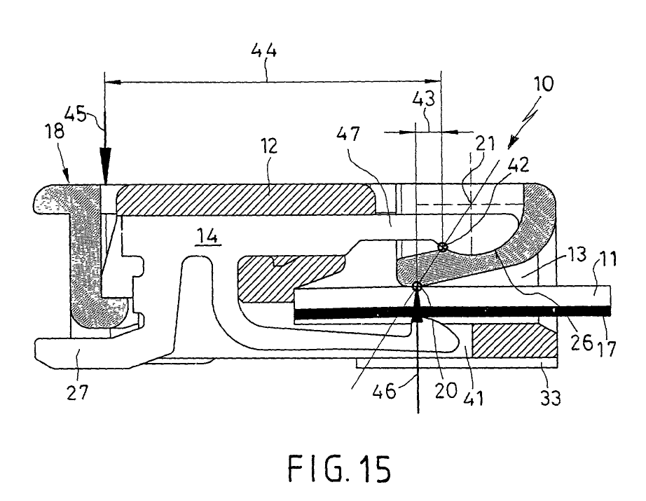

FIG. 15 shows how the pusher bar 20 is spaced by a distance 43 from the pivot 21 that is equal to around one-thirteenth of the effective length 44 of the lever formed by the part 18. Thus a small force 45 downward on the rear end of the part 18 creates a large force 46 between the portion 20 and teeth 16 to very solidly clamp the cable 17.

We claim:

1. A connector for a multiconductor ribbon cable, the connector comprising:
a plastic base part forming a transversely elongated slot open in a longitudinal insertion direction and formed with a plurality of seats spaced along and opening into the slot;
respective contact elements fixed in the seats and each having a deflectable contact arm with a contact point exposed in the slot at the respective seat to one side of the slot and a rigid pivot arm to an opposite side of the slot having an outer end spaced longitudinally outward from the respective contact point; and
a pivotal clamp part having a pusher bar extending along the slot inward of the arm outer ends, the clamp part being pivoted on the arm outer ends between an open position extending upward away from the base part and with the pusher bar spaced widely from the contact points and a closed position closely juxtaposed down on the base part and with, when an end of the ribbon cable is inserted in the slot, the pusher bar pressing the cable down on the points for contact of the cable conductors therewith.

2. The ribbon-cable connector defined in claim 1 wherein the arm outer ends have circularly arcuate bearing portion centered on a pivot axis, the pivotal element riding on the bearing portion for pivoting about the axis.

3. The ribbon-cable connector defined in claim 2 wherein the contact elements are of metal and flat, lying in respective planes extending in the direction and substantially perpendicular to the axis.

4. The ribbon-cable connector defined in claim 3 wherein the pivot arm is substantially wider and stiffer than the contact arm.

5. The ribbon-cable connector defined in claim 1 wherein the clamp part has a rear end spaced in the direction inward from the pusher bar, the rear end and base part being formed with interengageable hook formations releasably retaining the clamp part in the closed position.

6. The ribbon-cable connector defined in claim 1 wherein the base part has an upper wall and the clamp part is formed with a central window in which the upper wall fits flush in the closed position.

7. The ribbon-cable connector defined in claim 1 wherein the parts are formed with interengaging formations preventing movement of the clamp part upward past the open position.

8. The ribbon-cable connector defined in claim 7 wherein the formations include a pair of sides on the clamp part having upwardly directed surfaces and downwardly directed surfaces on the base part confronting the upwardly directed side surfaces and engageable therewith in the open position.

9. The ribbon-cable connector defined in claim 8 wherein the sides are deflectable apart for fitting of the pivotal clamp part over the base part.

10. The ribbon-cable connector defined in claim 1 wherein each of the contacts has a foot projecting rearward from the base part and adapted to be soldered to a trace of a circuit board on which the base part is sitting.

11. The ribbon-cable connector defined in claim 1, further comprising
a pair of mounting brackets having base flanges adapted to be fixed to a circuit board on which the base part is sitting and side flanges forming pivot upwardly directed pivot surfaces on which the clamp part rides on movement between its positions.

12. The ribbon-cable connector defined in claim 11 wherein the side flanges are formed with projections extending in the direction and the base part is formed with seats open in the direction and snugly receiving the projections.

13. The ribbon-cable connector defined in claim 11 wherein the brackets are metal.
